(19) United States
(12) Patent Application Publication
(10) Pub. No.: US 2004/0178769 A1
(43) Pub. Date: Sep. 16, 2004

(54) Battery-condition detection

(76) Inventor: Christoph Wenger, Korntal-Muenchingen (DE)

Correspondence Address: KENYON & KENYON, ONE BROADWAY, NEW YORK, NY, 10004, US

(21) Appl. No.: 10/733,423

(22) Filed: Dec. 10, 2003

(30) Foreign Application Priority Data
Dec. 12, 2002 (DE) 102 58 034.0

(51) Int. Cl. H02J 7/04

(52) U.S. Cl. 320/131

(57) ABSTRACT

A battery-condition detection which requires no current sensor. The battery is connected to a microprocessor via a circuit configuration. This circuit configuration includes means for the voltage measurement, means for the voltage comparison and, optionally, for the temperature measurement, as well as means for generating a trigger pulse. This trigger pulse generates a voltage pulse at the battery. After averaging or filtering, the pulse response is utilized for determining the complex internal resistance of the battery, from which the battery condition is then estimated.

### FIELD OF THE INVENTION

The present invention relates to a battery-condition detection. Such a battery-condition detection is used, in particular, for vehicle batteries.

### BACKGROUND INFORMATION

It is conventional to provide various monitoring measures and to carry out certain methods for detecting the condition of vehicle batteries. One such method, as well as an associated device for detecting the condition of a battery, is described in, for example, German Patent Application No. 199 59 016. To carry out this method for detecting the condition of a battery, actual quantities such as the battery voltage, the battery current and the battery temperature or ambient temperature are measured and are used as input quantities for an evaluation electronics. These electronics for carrying out the conventional battery-condition detection, which, inter alia, include at least one model-based parameter estimator and one Kalman filter, are able to estimate the battery-charge-condition quantity from the measured actual quantities, so that it comes quite close to the actual value. Of necessity, the conventional battery-condition detection requires a current sensor which measures the battery current; however, such a current sensor causes additional costs and, under unfavorable circumstances, may also fail and therefore make it impossible to detect the battery condition.

Another battery-condition detection, with whose aid it is possible to provide information about the capacity and/or the ageing of the battery, particularly a vehicle battery, is based on estimating the battery condition on the basis of the ohmic internal resistance of the battery. To that end, a defined current pulse is fed to the battery and its reaction is evaluated. In so doing, however, it is assumed that, except for this current pulse, the battery is experiencing no further load, particularly that no other battery current is flowing; however, this cannot be assumed in normal operation.

### SUMMARY

In contrast, an example battery-condition detection arrangement in accordance with the present invention may have the advantage that it has a simple construction and does not have to fulfill any secondary conditions with respect to the battery load. This advantage is obtained by using a battery-condition detection arrangement without a current sensor system, and taking measures which prevent effects of the battery load, i.e., of the battery current, on the actual battery-condition detection. To that end, a known current pulse is superimposed on the battery current given by the overall system, thus, for example, by the vehicle electrical system, and the condition of the battery is derived from the pulse response. For that purpose, the complex internal resistance of the battery, which contains important information about the battery condition, is determined from the pulse response.

The effects of the total current on the result of the battery-condition detection may be minimized by special filterings, particularly utilizing the fact that the average value of the total current is approximately zero. Averagings are advantageously carried out so frequently that the pulse response becomes completely independent of the total vehicle current.

Thus, it is particularly advantageous that by a simple current sink, a voltage measurement and a temperature measurement, it is possible to reliably estimate the battery condition, although currents are able to flow into and out of the battery at the same time, as well.

### BRIEF DESCRIPTION OF THE DRAWING

An example embodiment is explained in detail in the following description and is shown in the Figure.

FIG. 1 shows a block diagram of an example battery-condition detection arrangement for a vehicle battery according to the present invention.

### DETAILED DESCRIPTION OF AN EXAMPLE EMBODIMENT

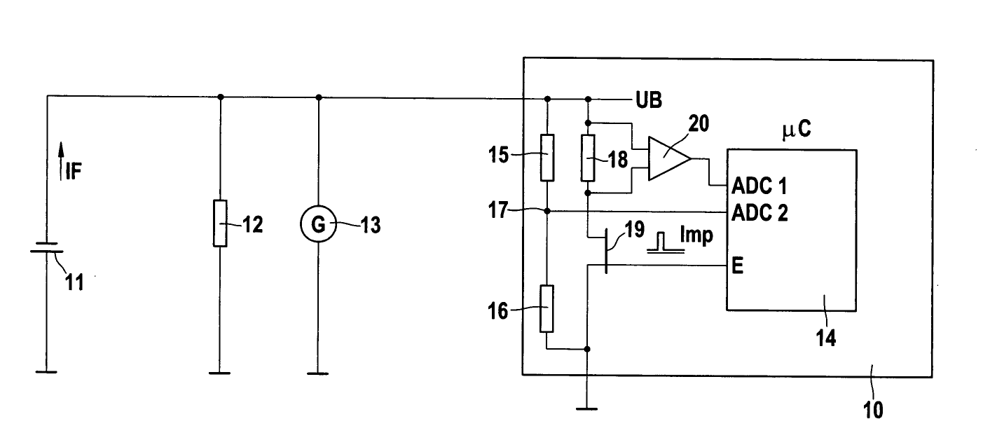

FIG. 1 shows a block diagram for carrying out a battery-condition detection for a vehicle battery. This battery-condition detection according to the present invention is implemented in a control unit for battery-condition detection 10, and operates without current measurement.

FIG. 1 shows a battery 11, particularly a vehicle battery, whose state of charge is to be determined. FIG. 1 also shows a load 12 which, for example, is intended to symbolize the electrical-system consumers of the vehicle, as well as a generator 13 which is to make available the electrical energy for the supply of a vehicle electrical system and the associated components and is usually driven by an internal combustion engine (not shown). Battery 11, load 12 and generator 13 are connected in parallel to control unit 10 between vehicle-system voltage UB and ground. Control unit 10 includes a microprocessor 14 having analog-digital converters ADC1 and ADC2 as well as a further input E. Connected to the input of control unit 10 is the series connection of two resistors 15, 16 whose interconnection point 17 is connected to microprocessor 14 via ADC2. Connected in parallel to the series connection of resistors 15 and 16 is a further resistor 18, as well as the breaker gap of a transistor 19. Both series connections are connected between vehicle-system voltage UB and ground. The two inputs of a comparator 20 are connected to one or the other side of resistor 18. The output of comparator 20 leads via analog-digital converter ADC1 to the microprocessor 14. Input E of microprocessor 14 is connected to the base of transistor 19.

The functioning method of the battery-charge-condition detection may be described as follows:

A known current pulse Imp is superimposed on battery current IF predefined by the overall system, and the condition of the battery is derived from the pulse response. In this context, the complex internal resistance of the battery is determined from the pulse response. The complex internal resistance of the battery contains important information about the battery condition which is evaluated in microprocessor 14 of control unit 10. Since the pulse response, which is evaluated in microprocessor 14, is also influenced by total battery current IF, it is necessary to provide a suitable filtering. In this context, this fact is utilized that the average value of total current IF is approximately zero. Accordingly, given a suitably frequent averaging, the pulse response results independently of total battery current IF.

The evaluation principle of the battery-condition detection shown in FIG. 1 without current measurement is that the battery condition may be estimated by a simple defined current sink, a voltage measurement and a temperature measurement, although additional currents are flowing into and out of the battery. The voltage measurement is carried out in the control unit itself. The temperature measurement may be carried out using a separate sensor or in the control unit, or the temperature is available in the control unit in any case.

One possible specific embodiment provides for generating current pulse Imp by a transistor 19 as switch and an associated resistor. In this case, the transistor is controlled in a suitable manner by microprocessor 14. The voltage at the resistor and the battery voltage are sampled via the microprocessor or microcontroller, buffered and set off against each other. The voltage measurement itself takes place in control unit 10. The channel or analog-digital converter ADC1 measures the voltage at the load resistor, and therefore the current. The channel or analog-digital converter ADC2 measures the battery voltage. 5 ampere and a triggering duration of 20 ms are provided nominally for a suitable current pulse Imp.

To, for example, eliminate the influence of the vehicle electrical system or to reduce the effects of the continually flowing currents, the pulse response is averaged over a plurality of current pulses. Thus, for that purpose, a plurality of trigger signals are generated by control unit 10 at specifiable times for transistor 19. The resulting pulse response or pulse responses is/are evaluated in microprocessor 14, which, in principle, is also able to carry out the necessary filterings and averagings and has means suitable for this purpose.

The battery-condition detection may be carried out in a separate vehicle-electrical-system control unit, but may also be carried out in the engine control unit, it being assumed that the necessary information is exchanged via suitable connections.

What is claimed is:

1. A battery-condition detector for a battery, comprising:
a microprocessor; and
a circuit configuration connected to the microprocessor and arranged between the microprocessor and the battery, wherein the circuit configuration includes a voltage sensor, a voltage comparator, and a trigger pulse generator.

2. The battery-condition detector as recited in claim 1, wherein the battery is a vehicle battery, and the microprocessor is a component of a control unit.

3. The battery-condition detector as recited in claim 2, wherein the control unit is one of a vehicle-electrical-system control unit or an engine control unit.

4. The battery-condition detector as recited in claim 1, wherein the voltage comparator is configured to compare various measured voltages to each other, and to supply a comparison result to the microprocessor.

5. The battery-condition detector as recited in claim 1, wherein the trigger pulse generator includes a transistor whose base is triggered by the microprocessor for pulse generation.

6. The battery-condition detector as recited in claim 5, wherein the trigger pulse generator generates one or more current pulses at specifiable times or in response to specifiable conditions, which are supplied to the battery, and an ensuing change in voltage is ascertained.

7. The battery-condition detector as recited in claim 1, wherein the microprocessor is configured to determine a complex internal resistance of the battery starting from a measured voltage and a measured temperature, both of which are a function of a battery condition, and to estimate the battery condition therefrom.

8. The battery-condition detector as recited in claim 1, further comprising:
one of a filter or an averaging configuration, which evaluates a voltage of the battery taking into consideration at least two voltage values, which in each case result after feeding a pulse to the battery.

9. The battery-condition detector as recited in claim 8, wherein the filter or averaging circuit is a component of a control unit.

10. The battery-condition detector as recited in claim 9, wherein the filter or averaging circuit is a component of the microprocessor.
